(19) United States
(12) Patent Application Publication
(10) Pub. No.: US 2023/0136064 A1
(43) Pub. Date: May 4, 2023

(54) Priority-based graphics rendering for multi-part systems

(71) Applicant: META PLATFORMS TECHNOLOGIES, LLC, Menlo Park, CA (US)

(72) Inventors: Gregory Mayo Daly, Seattle, WA (US); Eugene Gorbatov, Sammamish, WA (US)

(21) Appl. No.: 17/519,437

(22) Filed: Nov. 4, 2021

(51) Int. Cl. G06T 1/20; G06F 9/48

(52) U.S. Cl. CPC G06T 1/20; G06F 9/4881; G06T 2200/04

(57) ABSTRACT

In an embodiment, a method involves receiving a viewpoint from a headset, receiving, from applications, assets to be rendered using the viewpoint, determining, for each of the assets, a priority score, identifying, based on the determined priority scores, a first subset and a second subset of the assets, instructing a GPU to render, within a first GPU frame, a first superframe using the first subset, enqueuing the first superframe for transmission to the headset with a first priority and at a first pre-scheduled time, instructing the GPU to render, within a second GPU frame, a second superframe using the second subset, and enqueuing the second superframe for transmission to the headset with a second priority lower than the first priority and at a second pre-scheduled time, wherein the GPU has a GPU framerate faster than a pre-scheduled timing interval for transmitting data from the computing system to the headset.

### TECHNICAL FIELD

This disclosure generally relates to generating graphics for an artificial reality scene.

### BACKGROUND

An augmented reality (AR) system may generally include a real-world environment that includes AR content overlaying one or more features of the real-world environment. In typical AR systems, image data may be rendered on, for example, a robust head-mounted display (HMD) that may be coupled through a physical wired or wireless connection to a base graphics generation device responsible for generating the image data. However, in some instances, in which the HMD includes, for example, lightweight AR glasses and/or other wearable electronic devices as opposed to more robust headset devices, the AR glasses or other lightweight wearable electronic devices may, in comparison, include reduced battery capacity, processing power, low-resolution cameras, and/or relatively simple tracking optics. Thus, graphics rendering may be performed by the base graphics generation device, and then the image frames may be provided to the AR glasses. However, because all of the graphics rendering is typically performed by the base graphics generation device prior to transmitting image frames to the AR glasses via a wireless link, potential end-to-end latency between the graphics rendering on the base graphics generation device and the reprojection of image frames on the AR glasses may be increased (e.g., leading to the possibility of latency-based image artifacts being displayed to the user). It may be thus useful to provide techniques to improve artificial reality systems.

### SUMMARY OF PARTICULAR EMBODIMENTS

The present embodiments include providing a priority based graphics rendering technique in which the graphics rendering frame rate is adjusted to a multiple of the heartbeat interval of the wireless link and the graphics rendering data is prioritized per rendering cycle. For example, in certain instances, the graphics rendering data may be segmented and prioritized (e.g., scored) based on how sensitive each segment of the graphics rendering data is to latency. For example, the higher latency sensitive graphics rendering data may be rendered during a first GPU rendering thread, while the lower latency sensitive graphics rendering data may be rendered during a subsequent GPU rendering thread. In this way, the latency of the higher latency sensitive graphics rendering data may be reduced to a single heartbeat interval of the wireless link. In certain instances, prioritizing (e.g. scoring) the graphics rendering data may be determined based on, but not limited to, image content (e.g., 2D objects vs 3D objects); object features (e.g., object edges and contours vs other features); application requirement (e.g., video game); developer preference; user head pose, user hand pose; user eye gaze; user activity; graphics data rendering deadline; whether objects are world-locked or head-locked; location of objects relative to a camera viewpoint; and so forth. In other instances, the present techniques may further include dynamically adjust the performance (e.g., processing speed) of the base graphics generation device based on the processing workload and the desired rendering deadline. For example, if an application or other process require that a frame be rendered within the 10 milliseconds (ms), the base graphics generation device may dynamically adjust its performance based on the processing workload, power capacity, and deadline, so as to complete the task within the deadline, for example, with only minimal impact to resource efficiency.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example embodiment of a priority-based graphics rendering technique.

FIG. 2 illustrates an example base graphics generation system.

FIGS. 3A-3B illustrate an example scene graph and corresponding scenes.

FIG. 3B illustrates an example augmented reality system.

FIG. 4 illustrates another example embodiment of a priority-based graphics rendering technique.

FIGS. 5A-5B illustrate examples of artificial reality display systems.

FIG. 6 is a flow diagram of a method of an example priority-based graphics rendering technique.

FIG. 7 illustrates an example computer network.

FIG. 8 illustrates an example computer system.

### DESCRIPTION OF EXAMPLE EMBODIMENTS

Because artificial reality devices involve creating digital scenes or superposing computer-generated imagery onto a view of the real world, they provide a platform for designers and engineers to provide new forms of information, entertainment, or methods of collaboration. For example, artificial reality devices may allow users to communicate, seemingly in person, over long distances, or assist users by informing them of the environment around them in an unobtrusive manner. Because artificial reality experiences can often be customized, the user's experience with artificial reality may be deeply personal and highly engaging if presented with sufficient clarity and convenience.

One way that artificial reality experiences can augment human ability is with computer-generated images and/or text added to the real world, as in an augmented or mixed reality. From this simple principle, a variety of compelling use cases can be considered. Labels (e.g., texts, glyphs, etc.) or images describing a real-world object may be fixed in the world space (e.g., location-aware labels acting as street signs or providing a live map of a bike path), or images fixed to a real-world object as it moves through the space (e.g., a label added to a bus as it going on its route that provides detailed information about its route or capacity). Labels could also be used to help a user navigate through an unfamiliar city (e.g., creating a waypoint for the nearest restroom), or help find a friend in a crowd (e.g., a socially-aware waypoint fixed to another user). Other experiences worth considering may be based on interactions with real-world objects. For example, a user could “project” video onto a wall or screen that allows for the video to be played and visible to only herself or to others with access to a shared augmented space. As another example, a user could fix computer-generated text to a physical object to act as an augmented-reality book or magazine. Content could be displayed relative to the object (allowing a user to physical asset aside an augmented-reality) or could be displayed in a fixed relation to the user's (e.g., a tutorial video constantly playing in a corner of the view). Presented media could be customized to the user, so that the same content display space could content relevant to each person viewing the same physical space. As another example, a user could interact with computer-generated graphics by “touching” an icon, or “manipulating” the computer-generated images manually. These graphics could be shown to multiple users working on a project, enabling opportunities for team collaboration (e.g., multiple architects working on a three-dimensional digital prototype in a building together in real-time).

To facilitate use, the display that outputs the computer-generated graphics should be intuitive, constantly accessible, and unobtrusive. One approach for displaying high definition artificial reality graphics to a user is based on a head-mounted display. The user wears an apparatus, such as a visor, headset, or glasses, capable of displaying computer graphics display. In augmented or mixed reality experiences, the computer graphics can be seen alongside, or on top of, the physical world. However, rendering these computer graphics is computationally intensive. Therefore, in most cases rendering is performed by powerful computers communicatively attached (e.g., via a cable or wireless communication protocol, such as Bluetooth) to a head-mounted display. In such a configuration, the head-mounted display is limited by bulky cords, bandwidth and power limitations, heat restrictions, and other related constraints. Yet, the limits of these constraints are being pushed. Head-mounted displays that are comfortable and efficient enough for day-long wearing, yet powerful enough to display sophisticated graphics are currently being developed.

One technique used to reduce actual display size without impacting apparent display size is known as a scanning display. In a scanning display, multiple smaller images are combined to form a larger composite image. The scanning display uses source light, one or more scanning elements comprising reflectors, and an optics system to generate and output image light. The output image light may be output to the eye of the user. The source light may be provided by emitters, such as light-emitting diodes (LEDs). For example, the light source may be an array of 2560×1440 LEDs. The reflectors may be any suitable reflective surface attached to the scanning element. In particular embodiments, the scanning element may be a scanning mirror driven using one or more microelectromechanical systems (MEMS) components. The optics system may comprise lenses used to focus, redirect, and otherwise augment the light. The scanning element may cause the source light, treated by light guiding components, to be output to the eye of the user in a specific pattern corresponding to a generation pattern used by the emitters to optimize display draw rate. Because, for example, all emitters need not be active at once, and in addition to a variety of other factors, scanning displays may require less power to run, and may generate less heat, than traditional display comprised of the same emitters. They may have less weight as well, owing in part to the quality of the materials used in the scanning element and optics system. One consequence of using a scanning display is that in exchange for, e.g., power, weight, and heat efficiency, a scanning displays may not perfectly display images as presented to them, e.g., images intended for traditional displays. There may be non-uniform distortions such as geometric warping of images and distortion of colors and specifically brightness. As is explained further herein, these distortions can be corrected by post-processing graphics to-be displayed to counteract the distortion before they are passed to the display, creating the effect that there is no distortion. Although this disclosure describes displays in a particular manner, this disclosure contemplates any suitable displays.

Since its existence, artificial reality (e.g., AR, VR, MR) technology has been plagued with the problem of latency in rendering AR/VR/MR objects in response to sudden changes in a user's perspective of an AR/VR/MR scene. To create an immersive environment, users may need to be able to move their heads around when viewing a scene and the environment may need to respond immediately by adjusting the view presented to the user. Each head movement may slightly change the user's perspective of the scene. These head movements may be small but sporadic and difficult, if not impossible, to predict. A problem to be solved is that the head movements may occur quickly, requiring that the view of the scene be modified rapidly to account for changes in perspective that occur with the head movements. If this is not done rapidly enough, the resulting latency may cause a user to experience a sensory dissonance that can lead to virtual reality sickness or discomfort, or at the very least, a disruption to the immersive nature of the experience.

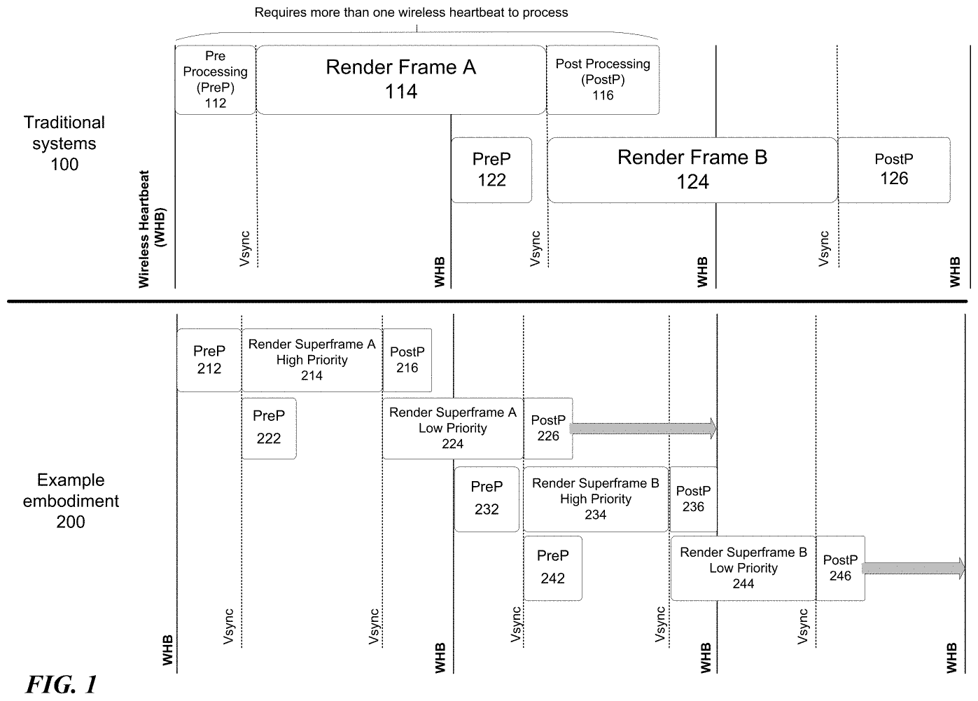

Particular embodiments described herein are directed to a base graphics generation system that is wirelessly coupled to a headset display device (HMD) and how the base graphics generation system (or otherwise referred herein as a “Stage”) renders artificial reality content and communicates the rendered content to the HMD. FIG. 1 illustrates an example of a priority-based graphics rendering technique (bottom half of FIG. 1) and a traditional technique (top half). The wireless heartbeats (WHB) illustrated in FIG. 1 represent time intervals at which a Stage communicates with an HMD. The interval of the WHBs may be a fixed period, e.g., 45 Hz or 60 Hz, or approximately every 22.22 ms or 16.67 ms. The Vsync illustrated in FIG. 1 represents the graphics processing unit (GPU) framerate, e.g., time intervals during which the GPU renders graphic content for a particular frame. Ideally, GPU vsync and wireless heartbeat are aligned in a way that allows the GPU to finish rendering the frame right before wireless interval starts. However, due to the latency resulting from the rendering process, the GPU typically does not have enough time to render and transmit an entire frame within one wireless heartbeat from when the camera pose is received. The delayed transmission of the rendered content may result in latency-based image artifacts being displayed to a user. The top half of FIG.1 illustrates this problem, where it shows that the rendering process for Frame A, including the post-processing, takes longer than one wireless heartbeat. For example, referring to the top half of FIG. 1, the rendering process may begin at the Pre Processing 112 box. At this step, the Stage may receive positional and/or sensor data from the HMD (e.g., camera pose). The Stage then determines which assets should be render into a frame, and, at the Render Thread Frame A 114 box, the Stage instructs the GPU to render Frame A. Subsequently, at the Post Processing 116 box, the rendered content is processed (e.g., packaged and compressed) for transmission to the HMD. As shown in FIG. 1, the time needed to render and process Frame A exceed a single wireless heartbeat (e.g., two). That is, by the time the Stage sends the rendered frame to the HMD, two wireless heartbeats have passed, and the pose used to render Frame A may be outdated when the rendered Frame A is displayed on the HMD.

The embodiments disclosed herein provide a solution to the problem discussed above by prioritizing assets within a particular frame, increasing the GPU framerate (Vsync), separating assets into one or more groups based on the prioritization, and rendering the groups into separate sub-frames, or “superframes.” For example, high-priority assets may be grouped together and rendered into a first superframe using an increased GPU framerate, such that the first superframe can be sent to the HMD within one wireless heartbeat from the time the camera pose is received. The low-priority assets may be placed in another group (or multiple groups), which are then rendered and processed into additional superframes and sent to the HMD in subsequent wireless heartbeats. This technique allows high-priority assets to be rendered and sent to the HMD within a single wireless heartbeat (e.g., 45 Hz or 60 Hz) while low-priority assets are rendered and sent to the HMD at subsequent wireless heartbeats. The bottom half of FIG. 1 illustrates this technique. The example embodiment 200 in FIG. 1 shows that the GPU framerate, or Vsync, is approximately double the rate of the Vsync shown in the traditional systems 100, meaning the rendering time, per each GPU frame, is approximately reduced in half. In the example embodiment 200, assets that are to be rendered for Frame A are separated into two groups: high-priority and low-priority. At the Render Superframe A—High Priority 214 step, the assets in the high-priority group are rendered and processed into a first superframe and transmitted to the HMD at the second wireless heartbeat (at the first wireless heartbeat, the Stage may receive pose and positional data from the HMD). At the Render Superframe A—Low Priority 224 step, assets in the low-priority group are rendered and processed into a second superframe to be transmitted at the third wireless heartbeat. The assets that are to be rendered for Frame B are similarly prioritized and rendered into two superframes. The high-priority assets of superframe B may be rendered and sent to the HMD at the same wireless heartbeat as the low-priority assets of superframe A. In particular embodiments, each of the superframes A (both the high- and low-priority assets) may be rendered using the same camera pose, for example, the camera pose received at the PreP 212. Similarly, each of the Superframes B (both the high- and low-priority assets) may be rendered using the same camera pose, for example, the camera pose received at the PreP 232.

In particular embodiments, when two or more frames or superframes are sent to the HMD at the same wireless heartbeat, frames or superframes with higher-priority assets may be sent to the HMD first. For example, in the example embodiment 200 illustrated in FIG. 1, it can be seen that superframe A with low priority assets 224 and superframe B with high priority assets 234 are ready to be sent to the HMD at the same wireless heartbeat (e.g., the third wireless heartbeat). In such a scenario, the superframe B with the high priority assets may be placed in the wireless transmission queue before the superframe A with the low priority assets to allow the HMD to receive the high priority assets first.

In particular embodiments, the GPU framerate may be dynamically adjusted (e.g., at a multiple of the wireless heartbeat), such that a particular number of superframes may be rendered and processed for transmission within a particular number of wireless heartbeats. For example, the embodiment 200 of FIG. 1 shows that the GPU framerate has been increased to allow the third rendering task (Superframe B corresponding to high priority assets) to be completed prior to the third wireless heartbeat.

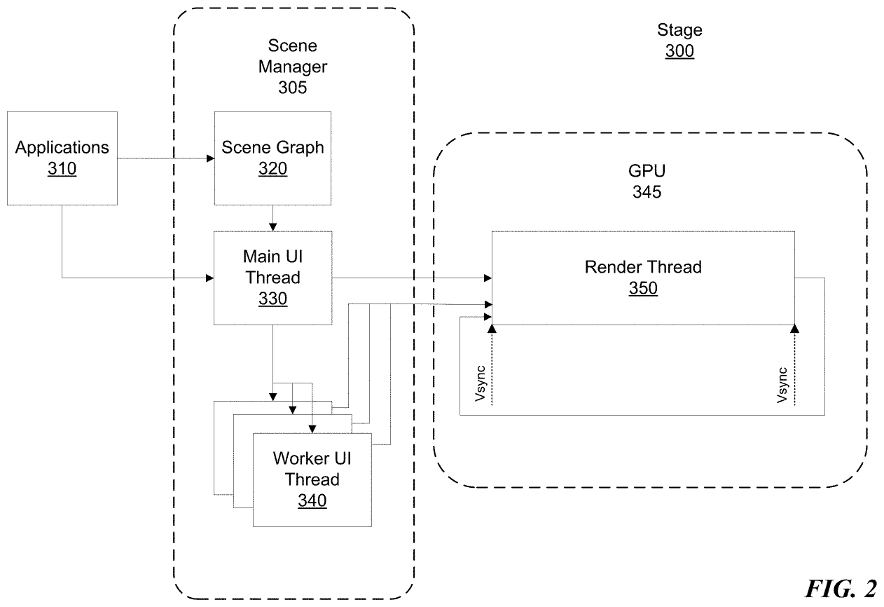

FIG. 2 illustrates an example artificial reality graphics rendering system 300, e.g., components of a Stage 300. As depicted, components of a Stage 300 may include applications 310, scene manager 305, and GPU 345. In particular embodiments, the Stage 300 may host and service applications 310, which may include artificial reality experiences displayed on an HMD. For example, the applications 310 may include video gaming applications (e.g., single-player games, multi-player games, first-person point of view (POV) games), mapping applications, music playback applications, video-sharing platform applications, video-streaming applications, e-commerce applications, social media applications, user interface (UI) applications, or other AR/VR applications. In particular embodiments, the applications 310 or other AR/VR content may be analyzed and managed by a scene manager 305. In particular embodiments, the scene manager 305 may analyze and manage 3D content obtained from applications 310 (e.g., geometry, texture, etc.) and keep track of the available hardware and/or software components for hosting and servicing the applications 310 or other AR/VR content. In particular embodiments, the scene manager 305 may maintain and keep track of pose information (e.g., head pose data, object pose data) received from the HMD. In particular embodiments, the scene manager 305 may utilize the main UI thread 330 to read a scene graph and perform transformation updates to the assets. In particular embodiments, the scene manager 305 may, via the main UI thread 330, issue worker UI Threads 340 to generate and update assets' geometry and/or texture.

In particular embodiments, in order to determine the priority of assets that are to be rendered, the scene manager 305 may determine a priority score for each of the assets. The priority scores are determined based on various factors/determinants, including the type of the asset (e.g., 2D object vs. 3D object), lock of the asset (e.g., world-locked, body-locked, hand-locked, head-locked), distance between the asset and a user, size of the asset, visibility of the asset, focus of a user's gaze, and application-specific factors (e.g., assets for gaming application, assets for text application). For example, world-locked objects may be assigned a higher priority score than head-locked objects; objects appearing within the FOV of a user may be assigned a higher priority score than objects appearing outside of the FOV (e.g., relative to the screen or, if eye-tracking is available, relative to the user's gaze); objects with complex geometry (e.g., more triangles, irregular shape) may be assigned a higher priority score than object with less-complex geometry; objects with complex shading (e.g., color) may be assigned a higher priority score than object with less-complex shading; large objects may be assigned a higher priority score than smaller objects; objects that are closer to a user may be may be assigned a higher priority score than objects that are further away; 3D objects may be assigned a higher priority score than 2D objects; videos may be assigned higher objects associated with certain applications (e.g., gaming application) may be assigned a higher priority score than objects associated with other applications (e.g., weather widget); and assets or applications that are currently in focus based on user interaction may be assigned a higher priority score than assets or applications that are not in focus.

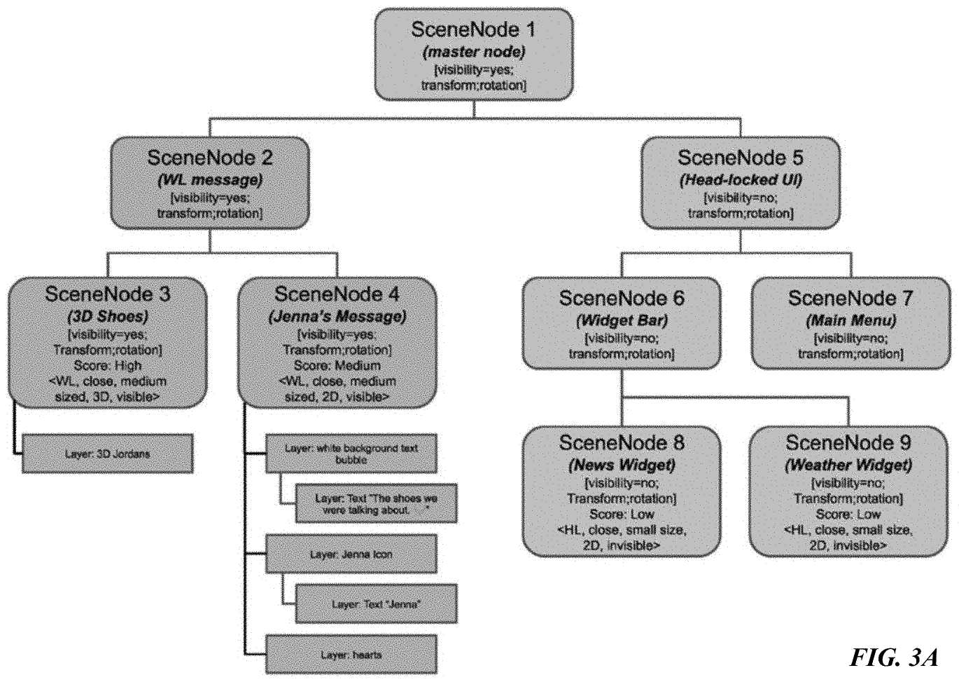

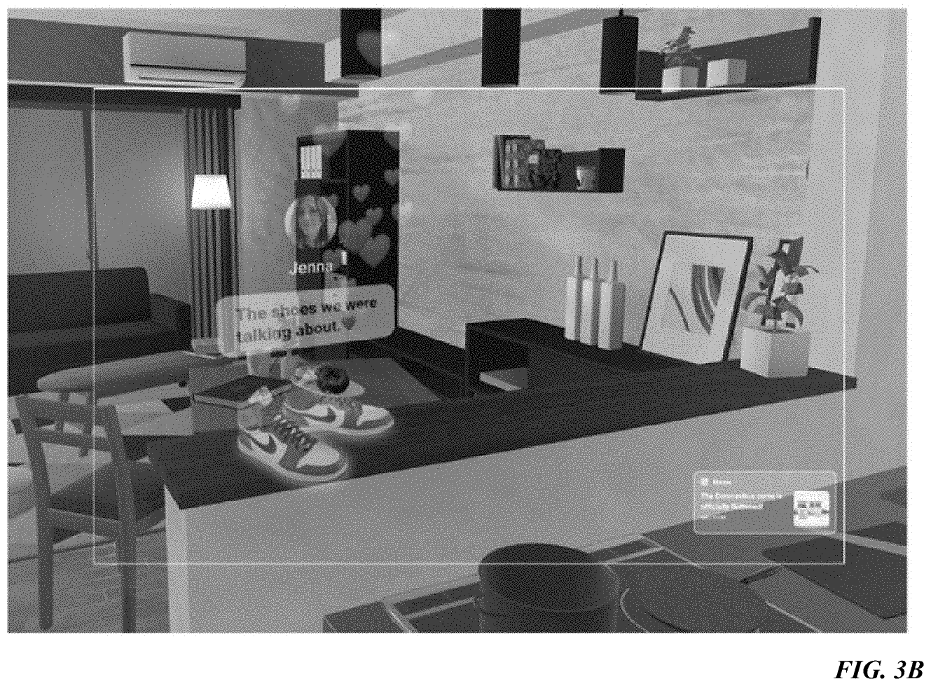

In particular embodiments, a scene manager 305 may generate and maintain a scene graph 320 to organize and keep track of the factors/determinants used to determine the priority scores. A scene graph consists of nodes, arranged in a tree structure, and can be used to organizes and controls the rendering of its constituent objects. FIG. 3A shows an example scene graph with various SceneNodes and their constituent objects, and FIG. 3B illustrates an example of how these objects may look when rendered. Referring to FIG. 3A, the scene manager 305 may determine that SceneNode 3 should be assigned a high priority score because its asset, 3D shoes, is visible to the user, distanced close to the user, is a 3D object, and is medium in size. The scene manager 305 may determine that SceneNode 4 should be assigned a medium priority score rather than a high priority score because its asset, a text message, while having similar characteristics as the 3D shoes, is a 2D object. The scene manager 305 may similarly determine that SceneNode 8 should be assigned a low priority score based on the characteristics of its asset, a news widget (e.g., small in size, a 2D object, and partially invisible). Based on these scores, the scene manager 305 may determine that the 3D shoes should be rendered first, followed by the text message, then the news widget.

In particular embodiments, the scene manager 305 may determine how to segment or separate out the assets into one or more groups in a dynamic fashion, for example, by first instructing the GPU to render the highest-priority assets, then checking to see whether there is sufficient time to render the next group of assets before the next wireless heartbeat (with sufficient time to allow post-processing of the rendered content). For example, referring to the scene graph shown in FIG. 3A, the scene manager 305 may instruct the GPU to first render the highest-priority scene (3D shoe) then determine whether there is sufficient time remaining to render the next scene before the next wireless heartbeat. If yes, the scene manager 305 may instruct the GPU to render the next priority scene (text message) in the same superframe as the 3D shoe. Then, if the scene manager 305 determines that there is not enough time to render the next priority scene (news widget), the scene manager 305 may place the news widget into a second group to be rendered into a second superframe.

In particular embodiments, the scene manager 305 may determine how to segment or separate out the assets or SceneNodes in one or more groups by predicting the amount of rendering time each asset or SceneNode will require. For example, referring to the scene graph shown in FIG. 3A, the scene manager 305 may analyze the SceneNode 3 and, based on the characteristics of the asset (3D shoe), determine that SceneNode 3 is the only scene that can be rendered before the next rendering deadline. In such a scenario, the scene manager 305 may assign SceneNode 3 in the first group (e.g., for the first superframe). The scene manager 305 may then similarly determine that SceneNodes 4 and 8 can both be rendered before the second wireless heartbeat and instruct the GPU to render both scenes in to a second superframe prior to the second wireless heartbeat. In particular embodiments, the scene manager 305 may predict the amount of rendering time each asset or SceneNode will require based on historical data indicating the amount of time a particular type of asset takes for rendering. In other embodiments, the prediction may be made based on the amount of memory read or write that a particular asset will require for rendering, for example, based on the number of triangles or vertices in the geometry, size of the source texture, color depth of the source texture, distance of the object to the camera, etc. In some embodiments, the prediction may be made based on the same or similar determinants used to determine the priority scores. In yet other embodiments, the amount of rendering time each asset or SceneNode will require may be provided by the applications that provide the assets.

In particular embodiments, the applications 310 may perform the rendering tasks on their own and send the rendered content to the scene manager 305. In particular embodiments, the scene manager 305 may instruct the applications on how to prioritize the assets based on similar methods described above. The scene manager 305 may then utilize a compositor assemble the various images of the assets.

In particular embodiments, the GPU frequency may be dynamically adjusted based on the workload and the desired rendering deadline. While GPUs typically run at a frequency needed to support a target frame rate (e.g., 2 GHz), GPUs do not adjust their performance level to meet the rendering deadline of individual assets within a scene. This is not power-efficient since the relationship between power consumption and processing frequency is not linear (e.g., if processing at 1 GHz for a certain time period takes n Watts, processing at 2 GHz for the same amount of time might take 4n Watts). In particular embodiments, the GPU's frequency is adaptively adjusted based on the workload and the desired rendering deadline. For example, if a system wants a certain number of assets to be rendered within 25 ms, it could assess how much workload there is to see how fast the GPU needs to run in order to complete the task on time. If there isn't that much work to be done, the GPU, rather than doing a sprint and then stop during that 25 ms, could instead walk for 25 ms to complete the same workload. By adaptively slowing down, the GPU would expend a lot less power. For another example, referring to FIG. 3A, if the scene manager 305 determines that SceneNode 8 should be rendered into a second superframe but the GPU is expected to finish the rendering task early (determined based on the methods of predicting the amount of rendering time discussed above), the scene manager 305 may instruct the GPU to lower it's frequency so that the rendering task completes slower, or with just enough time to post-process and transmit the rendered content to the HMD before a particular wireless heartbeat. In particular embodiments, the GPU frequency may be adjusted during runtime, for example, halfway through the GPU frame.

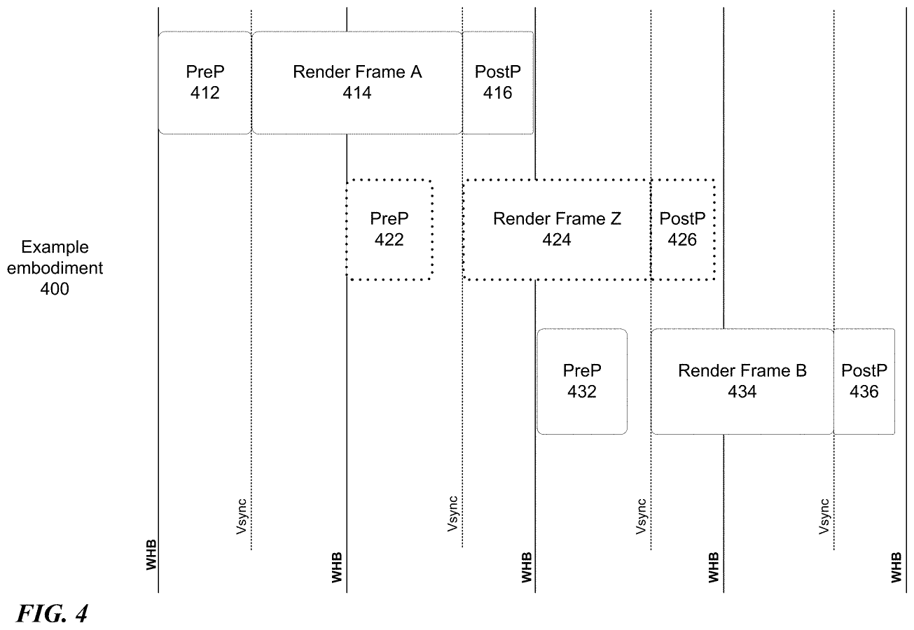

In particular embodiments, when there is sufficient amount of GPU idle time in between the rendering tasks, the rendering tasks for a particular frame may be separated into multiple GPU framerates to utilize the GPU more efficiently. For example, FIG. 4 illustrates an embodiment 400 where Frame A is rendered and processed in two wireless heartbeats and Frame B is subsequently rendered and processed in the next two wireless heartbeats. Given that the GPU would be idle in between the rendering tasks for Frame A and Frame B, the scene manager 305 may separate the rendering tasks for Frame A into two groups such that high-priority assets are rendered first at the Render Frame A 414 box and low-priority assets are rendered at the Render Frame Z 424 box. In other words, the scene manager 305 may separate out the rendering tasks for Frame A into two frames such that the GPU renders the high priority assets in Frame A and the low priority assets in Frame Z, i.e., during the period when the GPU would have been idle. The significance of these embodiments is not necessarily for reducing the rendering latency because, in contrast to other embodiments disclosed herein, the GPU framerate is not increased (e.g., rendering all of the assets for Frame A still takes two wireless heartbeats), but rather these embodiments provide the GPU additional time to render assets. With this additional time, the GPU frequency could be adjusted, as discussed above, to utilize the GPU more efficiently. In particular embodiments, Frame Z illustrated in FIG. 4 may be rendered based on the pose received at the PreP 412 box. In other embodiments, Frame Z may be rendered based on a newly received pose at PreP 422 Box.

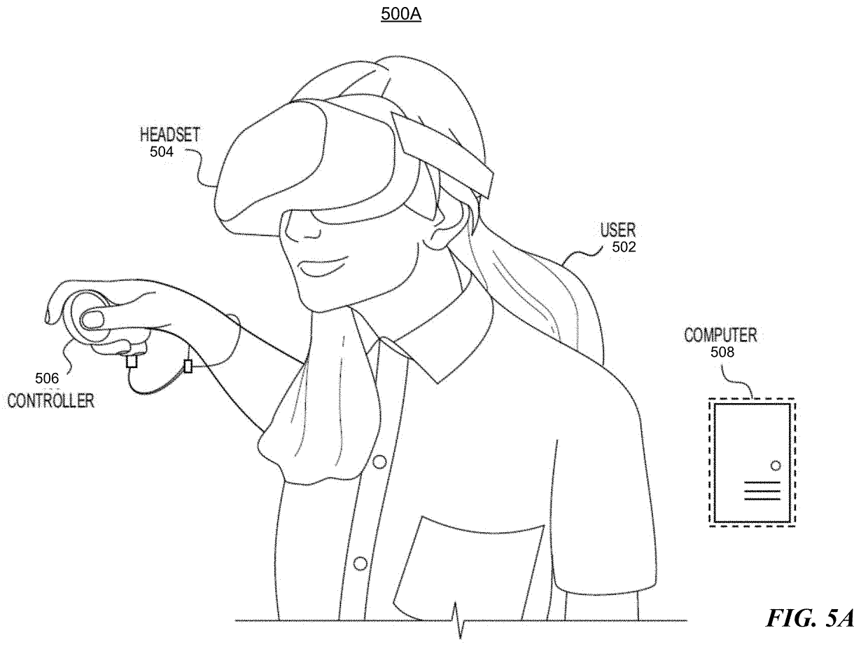

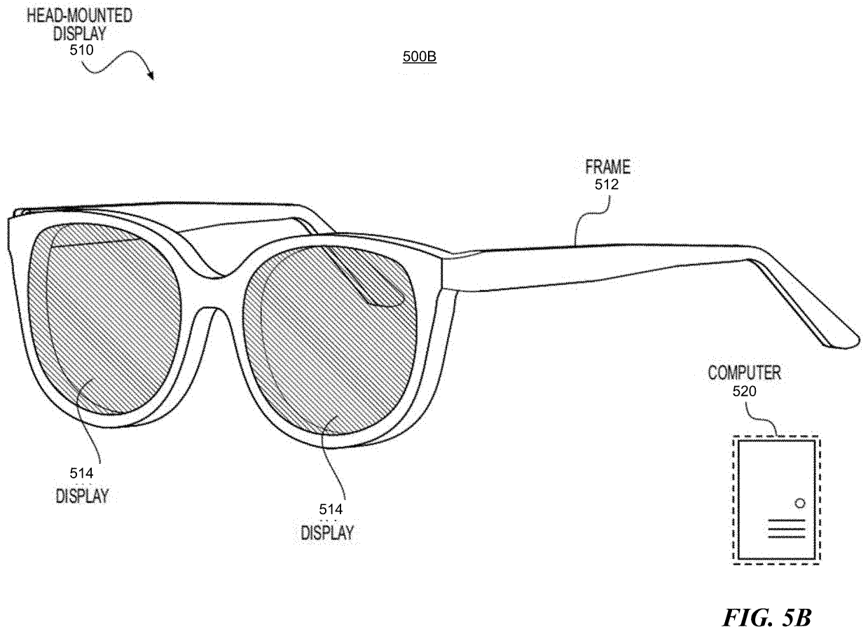

FIG. 5A illustrates an example artificial reality system 500A. In particular embodiments, the artificial reality system 500A may comprise a headset 504, a controller 506, and a computing system 508. A user 502 may wear the headset 504 that may display visual artificial reality content to the user 502. The headset 504 may include an audio device that may provide audio artificial reality content to the user 502. The headset 504 may include one or more cameras which can capture images and videos of environments. The headset 504 may include an eye tracking system to determine the vergence distance of the user 502. The headset 504 may be referred as a head-mounted display (HMD). The controller 506 may comprise a trackpad and one or more buttons. The controller 506 may receive inputs from the user 502 and relay the inputs to the computing system 508. The controller 206 may also provide haptic feedback to the user 502. The computing system 508 may be connected to the headset 504 and the controller 506 through cables or wireless connections. The computing system 508 may control the headset 504 and the controller 506 to provide the artificial reality content to and receive inputs from the user 502. The computing system 508 may be a standalone host computer system, an on-board computer system integrated with the headset 504, a mobile device, or any other hardware platform capable of providing artificial reality content to and receiving inputs from the user 502.

FIG. 5B illustrates an example augmented reality system 500B. The augmented reality system 500B may include a head-mounted display (HMD) 510 (e.g., glasses) comprising a frame 512, one or more displays 514, and a computing system 520. The displays 514 may be transparent or translucent allowing a user wearing the HMD 510 to look through the displays 514 to see the real world and displaying visual artificial reality content to the user at the same time. The HMD 510 may include an audio device that may provide audio artificial reality content to users. The HMD 510 may include one or more cameras which can capture images and videos of environments. The HMD 510 may include an eye tracking system to track the vergence movement of the user wearing the HMD 510. The augmented reality system 500B may further include a controller comprising a trackpad and one or more buttons. The controller may receive inputs from users and relay the inputs to the computing system 520. The controller may also provide haptic feedback to users. The computing system 520 may be connected to the HMD 510 and the controller through cables or wireless connections. The computing system 520 may control the HMD 510 and the controller to provide the augmented reality content to and receive inputs from users. The computing system 520 may be a standalone host computer system, an on-board computer system integrated with the HMD 510, a mobile device, or any other hardware platform capable of providing artificial reality content to and receiving inputs from users.

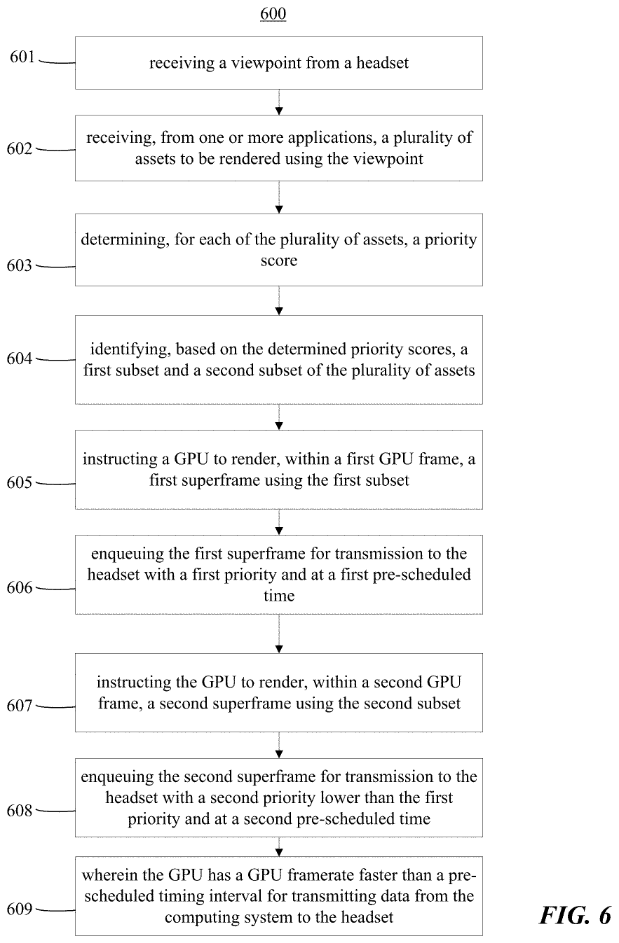

FIG. 6 illustrates an example method 600 for a priority based graphics rendering technique. The method may begin at step 604 by receiving a viewpoint from a headset. At step 602, the method may continue by receiving, from one or more applications, a plurality of assets to be rendered using the viewpoint. At step 603, the method may continue by determining, for each of the plurality of assets, a priority score. At step 604, the method may continue by identifying, based on the determined priority scores, a first subset and a second subset of the plurality of assets. At step 605, the method may continue by instructing a GPU to render, within a first GPU frame, a first superframe using the first subset. At step 606, the method may continue by enqueuing the first superframe for transmission to the headset with a first priority and at a first pre-scheduled time. At step 607, the method may continue by instructing the GPU to render, within a second GPU frame, a second superframe using the second subset. At step 608, the method may continue by enqueuing the second superframe for transmission to the headset with a second priority lower than the first priority and at a second pre-scheduled time. At step 609, the method specifies that the GPU has a GPU framerate faster than a pre-scheduled timing interval for transmitting data from the computing system to the headset. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for a priority based graphics rendering technique, this disclosure contemplates any suitable method for rendering graphics based on prioritization, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

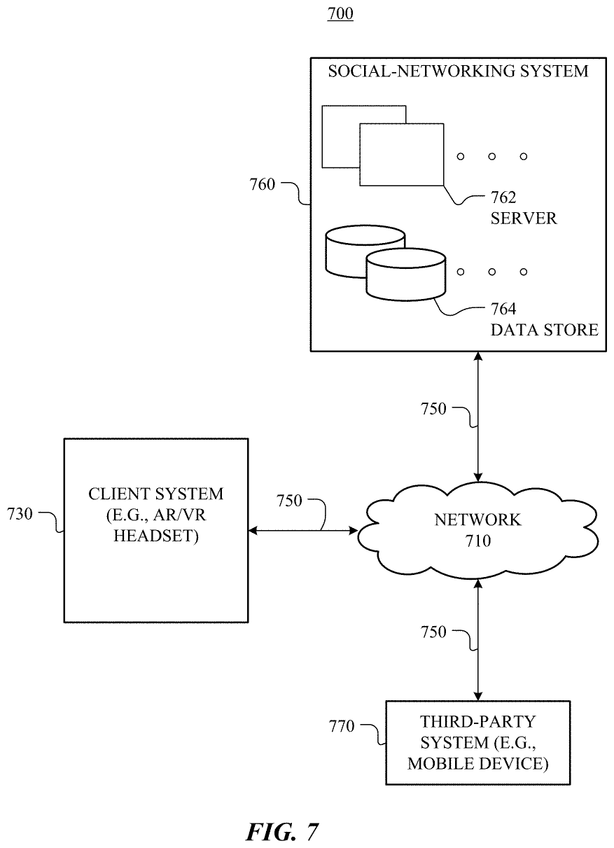

FIG. 7 illustrates an example network environment 700 associated with a social-networking system. Network environment 700 includes a user 701, a client system 730, a social-networking system 760, and a third-party system 770 connected to each other by a network 710. Although FIG. 7 illustrates a particular arrangement of user 701, client system 730, social-networking system 760, third-party system 770, and network 710, this disclosure contemplates any suitable arrangement of user 701, client system 730, social-networking system 760, third-party system 770, and network 710. As an example and not by way of limitation, two or more of client system 730, social-networking system 760, and third-party system 770 may be connected to each other directly, bypassing network 710. As another example, two or more of client system 730, social-networking system 760, and third-party system 770 may be physically or logically co-located with each other in whole or in part. Moreover, although FIG. 7 illustrates a particular number of users 701, client systems 730, social-networking systems 760, third-party systems 770, and networks 710, this disclosure contemplates any suitable number of users 701, client systems 730, social-networking systems 760, third-party systems 770, and networks 710. As an example and not by way of limitation, network environment 700 may include multiple users 701, client system 730, social-networking systems 760, third-party systems 770, and networks 710.

In particular embodiments, user 701 may be an individual (human user), an entity (e.g., an enterprise, business, or third-party application), or a group (e.g., of individuals or entities) that interacts or communicates with or over social-networking system 760. In particular embodiments, social-networking system 760 may be a network-addressable computing system hosting an online social network. Social-networking system 760 may generate, store, receive, and send social-networking data, such as, for example, user-profile data, concept-profile data, social-graph information, or other suitable data related to the online social network. Social-networking system 760 may be accessed by the other components of network environment 700 either directly or via network 710. In particular embodiments, social-networking system 760 may include an authorization server (or other suitable component(s)) that allows users 701 to opt in to or opt out of having their actions logged by social-networking system 760 or shared with other systems (e.g., third-party systems 770), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. In particular embodiments, third-party system 770 may be a network-addressable computing system that can host social media information or AR, VR, or MR content. Third-party system 770 may be accessed by the other components of network environment 700 either directly or via network 710. In particular embodiments, one or more users 701 may use one or more client systems 730 to access, send data to, and receive data from social-networking system 760 or third-party system 770. Client system 730 may access social-networking system 760 or third-party system 770 directly, via network 710, or via a third-party system. As an example and not by way of limitation, client system 730 may access third-party system 770 via social-networking system 760. Client system 730 may be any suitable computing device, such as, for example, a personal computer, a laptop computer, a cellular telephone, a smartphone, a tablet computer, or an augmented/virtual reality device.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, social-networking system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

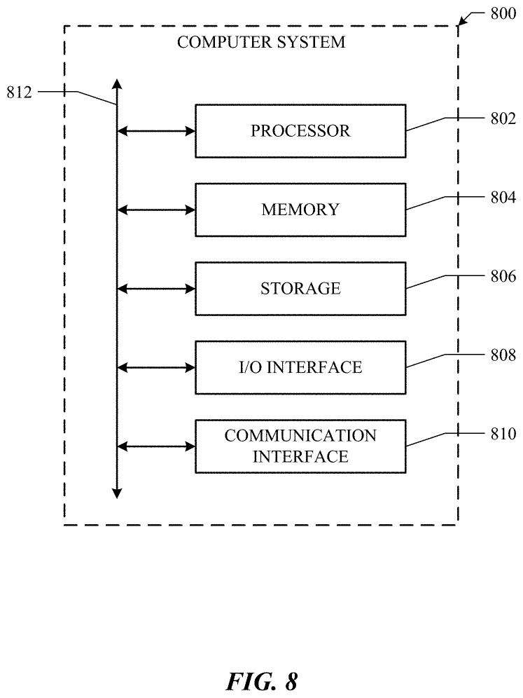

FIG. 8 illustrates an example computer system 800 that may be useful in performing one or more of the foregoing techniques as presently disclosed herein. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein.

As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate. In certain embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In certain embodiments, processor 802 includes hardware for executing instructions, such as those making up a computer program. As an example, and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example, and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802.

Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 602. Although this disclosure describes and illustrates a particular processor, this disclosure contemplates any suitable processor.

In certain embodiments, memory 804 includes main memory for storing instructions for processor 802 to execute or data for processor 802 to operate on. As an example, and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere).

One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example, and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In certain embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In certain embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In certain embodiments, communication interface 810 includes hardware, software, or both providing one or more interfaces for communication (such as, for example, packet-based communication) between computer system 800 and one or more other computer systems 800 or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it.

As an example, and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In certain embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
receiving a viewpoint from a headset;
receiving, from one or more applications, a plurality of assets to be rendered using the viewpoint;
determining, for each of the plurality of assets, a priority score;
identifying, based on the determined priority scores, a first subset and a second subset of the plurality of assets;
instructing a GPU to render, within a first GPU frame, a first superframe using the first subset;
enqueuing the first superframe for transmission to the headset with a first priority and at a first pre-scheduled time;
instructing the GPU to render, within a second GPU frame, a second superframe using the second subset; and
enqueuing the second superframe for transmission to the headset with a second priority lower than the first priority and at a second pre-scheduled time;
wherein the GPU has a GPU framerate faster than a pre-scheduled timing interval for transmitting data from the computing system to the headset.

2. The method of claim 1, wherein the GPU framerate is a multiple of the pre-scheduled timing interval.

3. The method of claim 1, wherein the priority score for each of the plurality of assets is determined based on determinants, the determinants including one or more of:
whether the asset is visible from the received viewpoint;
a distance between the asset and the received viewpoint;
a geometry of the asset;
a texture of the asset;
a size of the asset;
a shape of the asset;
the application of the one or more application from which the asset was received from;
whether the asset is a 2D object or a 3D object; and
whether the asset is a world-locked object, a head-locked object, a body-locked object, or a hand-locked object.

4. The method of claim 3, further comprising:
determining that the first superframe will be rendered faster than the GPU framerate; and
instructing the GPU to reduce a GPU frequency when rendering the first superframe.

5. The method of claim 4, wherein the determining that the first superframe will be rendered faster than the GPU framerate is based on an evaluation of the determinants corresponding to the first subset of the plurality of assets.

6. The method of claim 4, wherein the GPU is instructed to reduce the GPU frequency while the GPU is rendering the first superframe.

7. The method of claim 3, further comprising:
determining that the second superframe will be rendered faster than the GPU framerate; and
instructing the GPU to reduce a GPU frequency when rendering the second superframe.

8. The method of claim 7, wherein the determining that the second superframe will be rendered faster than the GPU framerate is based on an evaluation of the determinants corresponding to the second subset of the plurality of assets.

9. The method of claim 7, wherein the GPU is instructed to reduce the GPU frequency while the GPU is rendering the second superframe.

10. The method of claim 1, further comprising:
receiving a subsequent viewpoint from the headset;
receiving, from one or more of the applications, a plurality of additional assets to be rendered using the subsequent viewpoint;
determining, for each of the plurality of additional assets, a priority score;
identifying, based on the determined priority scores, a first subset of the plurality of additional assets;
instructing the GPU to render, within a third GPU frame, a third superframe using the first subset of the plurality of additional assets; and
enqueuing the third superframe for transmission to the headset with a third priority and at the second pre-scheduled time, wherein the third priority is higher than the second priority corresponding to the second superframe.

11. A system comprising: one or more processors; and one or more computer-readable non-transitory storage media in communication with the one or more processors, the one or more computer-readable non-transitory storage media comprising instructions that when executed by the one or more processors, cause the system to:
receive a viewpoint from a headset;
receive, from one or more applications, a plurality of assets to be rendered using the viewpoint;
determine, for each of the plurality of assets, a priority score;
identify, based on the determined priority scores, a first subset and a second subset of the plurality of assets;
instruct a GPU to render, within a first GPU frame, a first superframe using the first subset;
enqueue the first superframe for transmission to the headset with a first priority and at a first pre-scheduled time;
instruct the GPU to render, within a second GPU frame, a second superframe using the second subset; and
enqueue the second superframe for transmission to the headset with a second priority lower than the first priority and at a second pre-scheduled time;
wherein the GPU has a GPU framerate faster than a pre-scheduled timing interval for transmitting data from the computing system to the headset.

12. The system of claim 11, wherein the priority score for each of the plurality of assets is determined based on determinants, the determinants including one or more of:
whether the asset is visible from the received viewpoint;
a distance between the asset and the received viewpoint;
a geometry of the asset;
a texture of the asset;
a size of the asset;
a shape of the asset;
the application of the one or more application from which the asset was received from;
whether the asset is a 2D object or a 3D object; and
whether the asset is a world-locked object, a head-locked object, a body-locked object, or a hand-locked object

13. The system of claim 11, wherein the instructions, when executed by the one or more processors, further cause the system to:
determining that the second superframe will be rendered faster than the GPU framerate; and
instructing the GPU to reduce a GPU frequency when rendering the second superframe

14. The system of claim 13, wherein the determining that the second superframe will be rendered faster than the GPU framerate is based on an evaluation of the determinants corresponding to the second subset of the plurality of assets.

15. The system of claim 11, wherein the instructions, when executed by the one or more processors, further cause the system to:
receive a subsequent viewpoint from the headset;
receive, from one or more of the applications, a plurality of additional assets to be rendered using the subsequent viewpoint;
determine, for each of the plurality of additional assets, a priority score;
identify, based on the determined priority scores, a first subset of the plurality of additional assets;
instruct the GPU to render, within a third GPU frame, a third superframe using the first subset of the plurality of additional assets; and
enqueue the third superframe for transmission to the headset with a third priority and at the second pre-scheduled time, wherein the third priority is higher than the second priority corresponding to the second superframe.

16. One or more computer-readable non-transitory storage media including instructions that, when executed by one or more processors, are configured to cause the one or more processors to:
receive a viewpoint from a headset;
receive, from one or more applications, a plurality of assets to be rendered using the viewpoint;
determine, for each of the plurality of assets, a priority score;
identify, based on the determined priority scores, a first subset and a second subset of the plurality of assets;
instruct a GPU to render, within a first GPU frame, a first superframe using the first subset;
enqueue the first superframe for transmission to the headset with a first priority and at a first pre-scheduled time;
instruct the GPU to render, within a second GPU frame, a second superframe using the second subset; and
enqueue the second superframe for transmission to the headset with a second priority lower than the first priority and at a second pre-scheduled time;
wherein the GPU has a GPU framerate faster than a pre-scheduled timing interval for transmitting data from the computing system to the headset.

17. The one or more computer-readable non-transitory storage media of claim 16, wherein the priority score for each of the plurality of assets is determined based on determinants, the determinants including one or more of:
whether the asset is visible from the received viewpoint;
a distance between the asset and the received viewpoint;
a geometry of the asset;
a texture of the asset;
a size of the asset;
a shape of the asset;
the application of the one or more application from which the asset was received from;
whether the asset is a 2D object or a 3D object; and
whether the asset is a world-locked object, a head-locked object, a body-locked object, or a hand-locked object

18. The one or more computer-readable non-transitory storage media of claim 16, wherein the instructions are configured to further cause the one or more processors to:
determine that the second superframe will be rendered faster than the GPU framerate; and
instruct the GPU to reduce a GPU frequency when rendering the second superframe

19. The one or more computer-readable non-transitory storage media of claim 18, wherein the determining that the second superframe will be rendered faster than the GPU framerate is based on an evaluation of the determinants corresponding to the second subset of the plurality of assets.

20. The one or more computer-readable non-transitory storage media of claim 16, wherein the instructions are configured to further cause the one or more processors to:
receive a subsequent viewpoint from the headset;
receive, from one or more of the applications, a plurality of additional assets to be rendered using the subsequent viewpoint;
determine, for each of the plurality of additional assets, a priority score;
identify, based on the determined priority scores, a first subset of the plurality of additional assets;
instruct the GPU to render, within a third GPU frame, a third superframe using the first subset of the plurality of additional assets; and
enqueue the third superframe for transmission to the headset with a third priority and at the second pre-scheduled time, wherein the third priority is higher than the second priority corresponding to the second superframe.
